(19) United States
(12) Patent Application Publication
(10) Pub. No.: US 2021/0232100 A1
(43) Pub. Date: Jul. 29, 2021

(54) DISPLAY SYSTEM

(71) Applicant: ETA SA MANUFACTURE HORLOGERE SUISSE, Grenchen (CH)

(72) Inventors: Pascal LAGORGETTE, Bienne (CH); Xavier Stehlin, Cudrefin (CH); Romain Besuchet, Yverdon-les-Bains (CH); Raphaël Balmer, Vicques (CH)

(73) Assignee: ETA SA MANUFACTURE HORLOGERE SUISSE, Grenchen (CH)

(21) Appl. No.: 17/140,561

(22) Filed: Jan. 4, 2021

(30) Foreign Application Priority Data
Jan. 29, 2020 (EP) 20154404.6

(51) Int. Cl. G04C 17/00; G04B 19/04; G04G 9/00

(52) U.S. Cl. CPC G04C 17/0091; G04G 9/0082; G04B 19/042

(57) ABSTRACT

A display system (100) for a watch (200) and preferably of a watch (200) including a display device (110) configured to display an item of information, a pointing device (120) disposed above the display device (110) so as to define an overlap zone (130) and at least one movable element (140) disposed completely or partially above the display device (110) and at the periphery of the overlap zone (130) so as not to interfere with the capacitive or inductive field of the pointing device (120).

### CROSS-REFERENCE TO RELATED APPLICATIONS

This application claims priority to European Patent Application No. 20154404.6 filed Jan. 29, 2020, the entire contents of which are incorporated herein by reference.

### TECHNICAL FIELD

The present invention relates to the field of watchmaking, and more specifically that of display systems for displaying information on a dial. Preferentially, the present invention relates to the field of watch indicators and preferably connected water indicators.

### TECHNOLOGICAL BACKGROUND

Recent years have seen a boom in electronic watches and more specifically of watches comprising a capacitive or inductive pointing device.

The user can indicate a function that they wish to activate by making a contact with the screen by grazing or by touching, which gives rise to a modification of the capacitive or inductive field.

This modification of the field is disturbed by the hands which are located very close to the screen.

Existing solutions propose increasing the voltage or current in order to be less sensitive to disturbances, which inevitably results in an increase in electrical energy consumption and therefore reduces the autonomy of the electronic watch.

### SUMMARY OF THE INVENTION

The aim of the present invention is that of resolving all or some of the drawbacks mentioned above by means of a display system for a watch and preferably of a watch; said display system comprising at least:
a display device; said at least one display device being configured to display an item of information;
a pointing device; said at least one pointing device, preferably capacitive or inductive, being disposed above said at least one display device; said at least one display device and said at least one pointing device defining an overlap zone allowing the user to point on said at least one pointing device to said item of information of said at least one display device;
a movable element; said at least one movable element being disposed completely or partially above said at least one display device and at the periphery of said overlap zone.

Thanks to this arrangement, said at least one movable element cannot interfere with the capacitive or inductive field of said at least one pointing device.

According to an embodiment, said at least one movable element is disposed below and/or at the periphery of said at least one pointing device.

Thanks to this arrangement, said at least one movable element cannot interfere with the capacitive or inductive field of said at least one pointing device.

According to an embodiment, said overlap zone defines a display between said at least one display device and said at least one pointing device.

Thanks to this arrangement, said at least one movable element cannot interfere with the capacitive or inductive field of said at least one pointing device.

According to an embodiment, said at least one movable element is excluded from said overlap zone.

Thanks to this arrangement, said at least one movable element cannot interfere with the capacitive or inductive field of said at least one pointing device.

According to an embodiment, said overlap zone comprises at least 60%, preferably 85%, particularly 95% of said at least one display device.

Thanks to this arrangement, said overlap zone only partially overlaps said at least one display device which leaves a space for said at least one movable element.

According to an embodiment, said at least one movable element is an indicator, preferably a hand.

According to an embodiment, said at least one movable element is configured to be movable around said overlap zone.

### BRIEF DESCRIPTION OF THE FIGURES

The invention will be described hereinafter in more detail using the appended drawings, given as non-restrictive examples, wherein:

FIG. 1 illustrates a watch 200 comprising a display system 100 an embodiment according to the invention; and,

FIG. 2 shows a sectional view of the display system 100 an embodiment according to the invention; and,

### DETAILED DESCRIPTION OF THE INVENTION

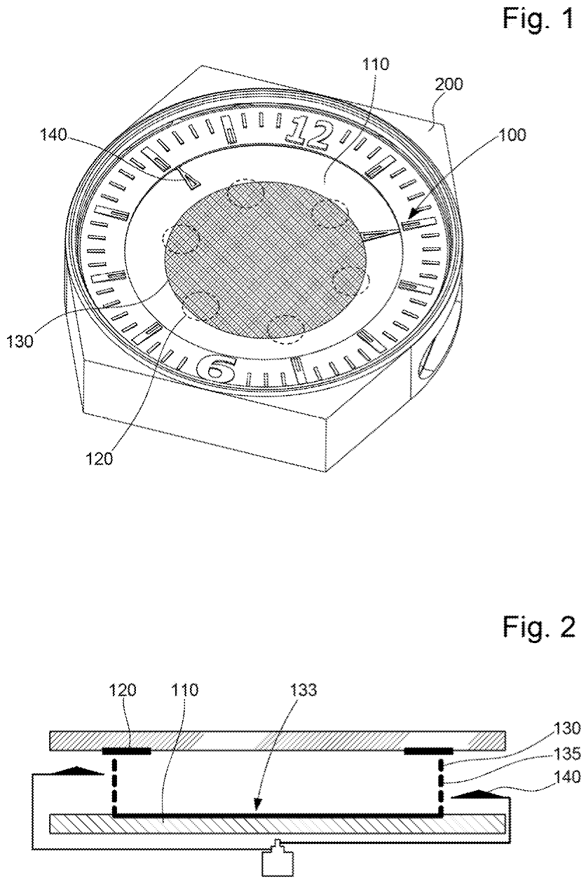

FIG. 1 represents a watch 200 with a display system 100 according to the invention. Said display system 100 for said watch 200 has at least one display device 110, preferably LCD or OLED, configured to display an item of information, at least one pointing device 120, preferably capacitive or inductive according to the embodiments, being disposed above said at least one display device 110. Said at least one display device 110 and said at least one pointing device 120 define an overlap zone 130, representing at least 60%, preferably 85%, particularly 95% of said at least one display device 110, allowing the user to point on said at least one pointing device 120 to said item of information of said at least one display device 110, as represented in la FIG. 2.

Indeed, said overlap zone 130 defines a display 133 between said at least one display device 110 and said at least one pointing device 120 allowing the user to select one or more functions or items of information that would be displayed.

To this at least one movable element 140 is added, which can take the form of an indicator, preferably a dial hand 140 and being movable around said overlap zone 130. This element, that is to say, said at least one movable element 140 can be disposed completely or partially above said at least one display device 110 and below and/or at the periphery of said at least one pointing device 120 so as to be at the periphery of said overlap zone 130 as shown in FIGS. 1 and 2. Thus said at least one movable element 140 cannot interfere with the capacitive or inductive field of said at least one pointing device 120.

Preferentially, said at least one movable element 140 is excluded from said overlap zone 130 so as to prevent said at least one movable element 140 from interfering with the capacitive or inductive field of said at least one pointing device 120.

Thus, the user can indicate a function that they wish to activate by making a contact with said at least one pointing device 120 by grazing or by touching, which gives rise to little or no modification of the capacitive or inductive field.

Moreover, the display system 100 according to the invention makes it possible to reduce the electrical energy consumption and therefore increases the autonomy of the electronic watch.

1. A display system for a watch and preferably of a watch; said display system comprising:
a display device, said display device being configured to display an item of information;
a pointing device, said pointing device being disposed above said display device, said display device and said pointing device defining an overlap zone allowing the user to point on said pointing device to said item of information of said display device;
a movable element, said movable element being disposed completely or partially above said display device and at the periphery of said overlap zone.

2. The display system according to claim 1, wherein said movable element is disposed below and/or at the periphery of said pointing device.

3. The display system according to claim 1, wherein said overlap zone defines a display between said display device and said pointing device.

4. The display system according to claim 1, wherein said movable element is excluded from said overlap zone.

5. The display system according to claim 1, wherein said overlap zone comprises at least 60% of said display device.

6. The display system according to claim 5, wherein said overlap zone comprises at least 85% of said display device.

7. The display system according to claim 5, wherein said overlap zone comprises 95% of said display device.

8. The display system according to claim 7, wherein said movable element is an indicator.

9. The display system according to claim 8, wherein said movable element is a hand.

10. The display system according to claim 1, wherein said movable element is configured to be movable around said overlap zone.

11. A watch comprising said display system according to claim 1.
